(19) United States
(12) Patent Application Publication
(10) Pub. No.: US 2024/0004856 A1
(43) Pub. Date: Jan. 4, 2024

(54) CONTENT METRIC GENERATION BASED UPON ACCESS TIME BY A USER

(71) Applicant: Lenovo (United States) Inc., Morrisville, NC (US)

(72) Inventors: Justin Ringuette, Morrisville, NC (US); Mark K Summerville, Apex, NC (US); Mark Chrisopher Heidenfeldt, Apex, NC (US); Sandy Collins, Durham, NC (US); Richard Todd Wall, Garner, NC (US)

(21) Appl. No.: 17/854,977

(22) Filed: Jun. 30, 2022

(51) Int. Cl. G06F 16/22

(52) U.S. Cl. CPC G06F 16/2291

(57) ABSTRACT

One embodiment provides a method, the method including: detecting, using a content access detection system, content as content being accessed by a user; tracking, using the content access detection system and while the content is being accessed by the user, an amount of time the content is being accessed by the user; and marking, using the content access detection system, the content with the amount of time, wherein the marking includes utilizing a technique that allows sorting of the content based upon the amount of time. Other aspects are claimed and described.

### BACKGROUND

With the prevalence of information handling devices (e.g., smartphones, smart televisions, laptop computers, personal computers, tablets, smart watches, digital assistant devices, etc.), users commonly use these devices to access content (e.g., files, Internet content, file folders, media, etc.). Digital content provides users access to greater amounts of information and other data than traditional non-digital content. For example, if a user is conducting research, the user can access digital files related to research papers, technical articles, and/or the like, across many different sources instead of having to gain access to hard copies of the publications, books, or other sources of the information.

### BRIEF SUMMARY

In summary, one aspect provides a method, the method including: detecting, using a content access detection system, content as content being accessed by a user; tracking, using the content access detection system and while the content is being accessed by the user, an amount of time the content is being accessed by the user; and marking, using the content access detection system, the content with the amount of time, wherein the marking includes utilizing a technique that allows sorting of the content based upon the amount of time.

Another aspect provides an information handling device, the information handling device including: a processor; a memory device that stores instructions that, when executed by the processor, causes the information handling device to: detect, using a content access detection system, content as content being accessed by a user; track, using the content access detection system and while the content is being accessed by the user, an amount of time the content is being accessed by the user; and mark, using the content access detection system, the content with the amount of time, wherein the marking includes utilizing a technique that allows sorting of the content based upon the amount of time.

A further aspect provides a product, the product including: a computer-readable storage device that stores executable code that, when executed by a processor, causes the product to: detect, using a content access detection system, content as content being accessed by a user; track, using the content access detection system and while the content is being accessed by the user, an amount of time the content is being accessed by the user; and mark, using the content access detection system, the content with the amount of time, wherein the marking includes utilizing a technique that allows sorting of the content based upon the amount of time.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for creating a content access metric for marking content to allow for sorting content by the content access metric.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The ability to access large amounts of information or data is useful and generally desired for many users. However, a problem with being able to access such a large amount of content is that much of the content may be irrelevant to the task at hand. However, the user may not know that the content is irrelevant until after opening the content. Once the content is accessed, metadata corresponding to the content is modified to reflect the access by the user, regardless of whether the content is useful to the user. When the user attempts to re-access content that the user did find to be relevant, the user may have a difficult time finding the correct content due to the large amounts of content that are accessible.

Thus, many systems allow a user to sort the content using metadata that corresponds to the content. For example, traditional systems may allow the user to sort content by content name, content size, content source, and/or other metadata that remains static regardless of whether a user accessed the content. Traditional systems also allow the user to sort the content using the metadata that was modified due to the access by the user, for example, date/time of last access, a frequency of access, and/or the like. However, these sorting techniques may not be helpful to the user in finding the relevant content, particularly if the user accessed many different pieces of content in a short time span. These accesses would result in the modified metadata being similar across all the content, even if the content is not relevant to the user.

Accordingly, the described system and method provides a technique for creating a content access metric for marking content to allow for sorting content by the content access metric. The content access detection system detects content as content being accessed by a user. Accessing not only refers to opening or saving the content, but also refers to having the content open. In other words, accessing encompasses not only the initial retrieval of the file, but also encompasses the consumption of the content by the user, for example, the user reading the content, the user listening to the content, the user manipulating the content, the user referring to the content, and/or the like. While the content is accessed by the user, the content access detection system tracks an amount of time that the content is being accessed. The content is marked with the amount of time metric, thereby allowing sorting of content based upon the amount of time metric.

Therefore, a system provides a technical improvement over traditional methods for sorting content. The described system and method provide a technique that allows a user to sort content based upon a length of access, thereby providing a technique that allows a user to sort content using a metric that is more likely to be associated with relevancy to a user than traditional sorting techniques. Instead of being able to sort content only based upon static metadata metrics or metadata that is manipulated as soon as the content is accessed, the described system keeps track of an amount of time that the content is accessed and is able to mark the content with the length of access metric. Accordingly, the described system provides a technique that allows a user to more easily re-find content, thereby saving the user time, providing a more user efficient system, and providing a more user-friendly content access system.

The illustrated example embodiments will be best understood by reference to the figures. The following description is intended only by way of example, and simply illustrates certain example embodiments.

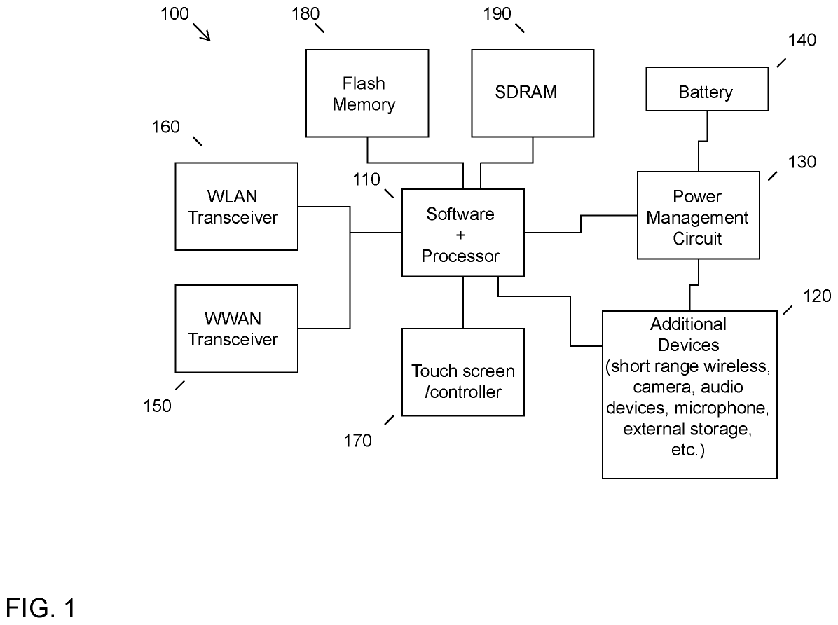

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

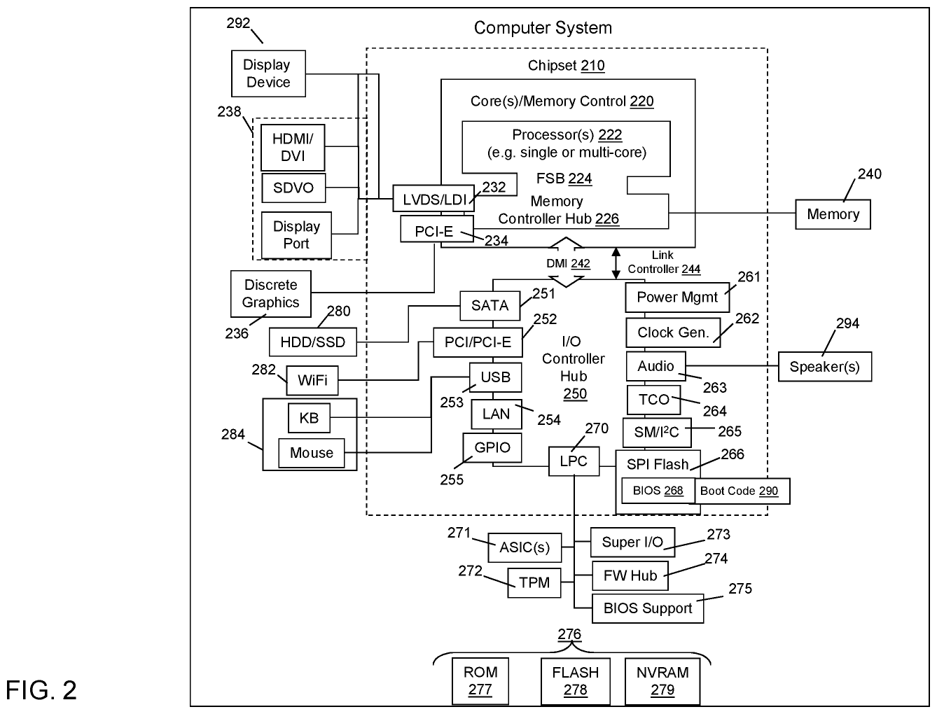

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in systems that create content access metrics and mark content with the content access metrics. For example, the circuitry outlined in FIG. 1 may be implemented in a tablet or smart phone embodiment, whereas the circuitry outlined in FIG. 2 may be implemented in a personal computer embodiment.

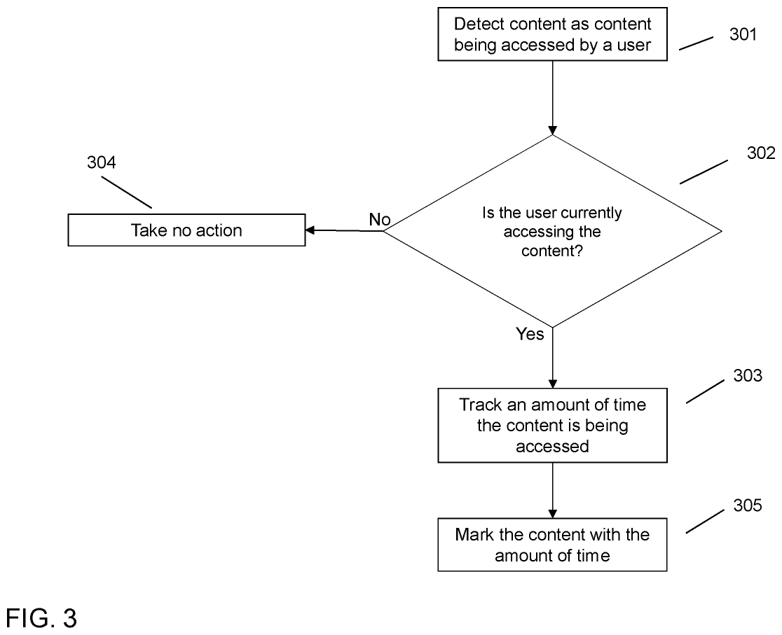

FIG. 3 illustrates an example method for creating a content access metric for marking content to allow for sorting content by the content access metric. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to create a content access metric and mark content with the content access metric. Additionally, the content access detection system includes modules and features that are unique to the described system.

The content access detection system may be an application that runs in the background as other programs, applications, and/or content accessible by the information handling device are accessed by a user. The content access detection system may be loaded or installed on an information handling device that a user is actively using. Additionally, or alternatively, the content access detection system may be loaded or installed on a secondary device or operatively coupled device that can communicate with an information handling device the user is actively using, for example, a cloud device, a remote device, a network device, and/or the like. As content is accessed by a user, the content access detection system can monitor the content to identify and monitor the content that is being accessed and perform the other functions of the content access detection system as described further herein. The content access detection system can be automatically loaded when an operating system or other underlying application is activated or loaded. The content access detection system may also be loaded upon receiving user input identifying that it should be loaded and activated, for example, the user selecting an icon associated with the content access detection system to open or load the system, the user performing an activation gesture, or other type of user input indicating that the content access detection system should be activated.

The content access detection system may be used in systems that include display devices that allow for display of content on one or more monitors, screens, displays, and/or other mechanism or device for providing a visual output of content, generally referred to as displays here throughout. This includes systems that may have one or more displays that are connected through a wired connection, a wireless connection, and/or a combination thereof. Additionally, the content access detection system may be used in systems that have no displays or other visible output devices. In these systems the output mechanism or device may be an audio output device, a haptic output device, a combination of output devices, and/or the like. The system may also include a display, but the content may be output using a modality different than a visual output, for example, audio output, haptic output, and/or the like.

The content access detection system may be employed with any content management systems, applications, and/or the like. In other words, the content access detection system can be used in conjunction with any type of system or application that provides for content management. Thus, the content access detection system can be utilized with Internet search engines, file management systems, and/or any other system where content can be accessed, filtered, sorted, stored, and/or the like. The term sorting will not only refer to traditional sorting where content is arranged based upon some metric or metrics, but also refer to other sorting-type functions, for example, filtering where content not meeting a particular criterion is removed from view or access. Filtering and sorting are similar in that the manipulation of the arrangement of the content is based upon a metric, usually a metadata metric. Thus, the described system can also be applied to other content manipulations that are performed based upon content metrics.

At 301, the content access detection system detects content as content being accessed by a user. The content access detection system monitors the information handling device that a user is using (referred to as an active information handling device) or that is operatively coupled to an active information handling device. When a user accesses content, the content access detection system can detect this access and take additional action with respect to the content. Accessing the content may include the user loading, opening, or otherwise activating content. For example, a user may access content within an Internet browser by selecting a link, opening a document or file from a website, accessing an Internet protocol address, or performing another action to make the Internet content active on the device. As another example, a user may access a file within a file management system and open the file, thereby making it active on the device. It should be noted that accessing content may be based upon the type of information handling device used to access the content. For example, accessing the content may include starting an audio output of the content, visually displaying the content on the device, and/or the like.

Accessing the content not only includes simply opening, loading, or otherwise activating the content, but also the user actually consuming the content. In other words, accessing encompasses not only the initial access of the content, but also the consumption of the content by the user. Thus, the content access detection system can not only detect that content has been opened, initiated, loading, or otherwise activating the content, but can also detect that the user is consuming content. The system may detect that content is being consumed based upon a characteristic of the content. Information handling device systems are able to identify applications that are active or foreground applications. When applications are active, characteristics of the applications are modified, for example, a color of the application title bar, availability of functions within the application, and/or the like. Thus, information handling device systems already have techniques for identifying applications as active or foreground applications. Content contained within applications that are active or foreground applications may be identified by the content access detection system as being consumed.

The content access detection system may also detect that a particular Internet protocol (IP) address or other identifier corresponding to the application and/or content is active on the information handling device, meaning the IP address or identifier is actively being accessed. Some information handling devices do not provide a function that allows for multiple windows to be displayed at a single time. In such devices, the detection of an active IP address, identifier corresponding to a particular application, and/or the like, indicates that the corresponding window is active and the only window that the user could be viewing. Thus, the system can identify that the user is consuming the content corresponding to or contained within the window. Such a technique can also be utilized for information handling devices that do allow for the display of multiple windows at a single time.

Active IP addresses or application identifiers may also provide an indication that a user is consuming content when the content is not being displayed, but rather being provided using a different output modality (e.g., audio, haptic, etc.). For example, if the content is being output on a speaker or other audio output device, an active IP address can be used to identify the source of the content. In the case of audio output, the system can also detect that a user is consuming content based upon identifying an active audio output application (i.e., an audio output application currently in playback mode) and identifying the content that is loaded, open, or otherwise being played by the audio output application. In other words, the system may detect that content is being actively accessed if the content is actively being audibly output. It should be noted that an audio output application does not have to be a stand-alone application. Rather, the audio output application could be a part of another application, for example, embedded within an Internet browser, embedded within a file, and/or the like. Example audio output applications include media players, text-to-speech software applications, embedded multimedia, and/or the like.

It is common to utilize information handling devices that allow for the display or provision of multiple windows or other content provision applications, devices, or other mechanisms. In this case, a user can consume content that is not contained within an active or foreground content provision mechanism. For example, a user may have two windows open on a display device with each taking up a visible portion of the display. The user can have one of the windows active and still see the content contained within the other open window, even though that window is not an active window. Accordingly, the content access detection system may use other techniques to determine if the user is actively accessing content contained within an inactive window or content provision mechanism. These techniques may also be used in conjunction with the techniques already described. Additionally, these techniques may also be used in lieu of the techniques already described, even on content that is currently active.

To detect that content is being consumed, the content access system may utilize one or more sensors of the active information handling device, operatively coupled to the active information handling device, communicating with the active information handling device, coupled to a secondary information handling device that can communicate with the active information handling device, a combination thereof, and/or the like. For example, if the content is displayed on one or more displays, the content access detection system may detect a location of a gaze of the user with respect to the displays using a gaze tracking sensor or other sensor that can detect a gaze and/or location of the gaze of the user. Once the gaze is detected, the system can correlate the location of the gaze with content that is being displayed on the screen. The system can identify the content that has been correlated to the location of the gaze as content that is being actively accessed by the user.

Another sensor that may be utilized is a voice, speech, and/or audio input detection sensor. As a user is consuming content, the user may provide voice or audible output with respect to content. For example, the user may read the content out loud, may make statements regarding the content, think out loud regarding the content, responding to the content, and/or the like. The content access detection system may capture this audio and correlate the audio to the content to determine that the content is being actively accessed by the user. For example, the system may parse the audio input and then correlate or identify words within the audio input that correspond to words or other information contained in the content. From this information, the system can determine that the user is actively accessing the content even if the window or other content provision mechanism is not active on the information handling device.

The system may also use characteristics of the window or other content provision mechanism to determine or infer that the user is actively accessing or consuming the content. Characteristics of the window or other content provision mechanism that may be utilized include, but are not limited to, a size of the window, a location of the window with respect to other content, a frequency of access of a particular window or content provision mechanism, the size of content within the window, content currently displayed within the window, and/or the like. For example, the content access detection system may determine that a window is of a size that takes up half of the display and that is not covered by other content on the display. Even though this window is not active, the system may determine that the content within the window is being actively accessed by the user.

The size does not have to be a particular size, but may be a size that allows for viewing or consumption of the content. For example, if the window is so small or positioned such that content within the window cannot be viewed, the system may determine that the user is not actively accessing the content. As another example, if the system determines that the content currently displayed within the window is likely not usable content (e.g., blank content, an advertisement, partial content like parts of words, content so large or small it is not readable, etc.), the system may determine that the content is not being actively accessed. The system can also use user history, user preferences, and/or the like, to determine if content is usable.

Sensors may also be used to detect whether the user is within proximity to the information handling device and/or content provision device. A user may have active content, but may not be actually consuming it. Thus, in conjunction within determining if content has been accessed, the content access detection system may also determine if the user is within proximity to the content to actually be accessing it. As an example, the content access detection system may identify a location of the gaze of the user as discussed above. If the gaze of the user is undetectable, meaning the user is looking away from the gaze detection or tracking sensor, the system may determine that the user is not actively accessing content even though the content may be active, visible, playing, or otherwise accessible on the device. Similarly, if the location of the gaze is detected as being at a position other than towards or at the content provision mechanism, the system may determine that the user is not actively accessing content event though the content may be active, visible, playing, or otherwise accessible on the device.

As another example, the system may utilize other sensors, devices, and/or mechanisms to detect the presence of a user, a location of a user with respect to the information handling device, a proximity of the user to the information handling device, and/or the like. For example, the content access detection system may employ or utilize proximity sensor or sensors, touch detection sensors, heat detection sensors, cameras or other image capture sensors, sensors or devices that can detect other information handling devices (e.g., communication mechanisms, signal strength detection, etc.), and/or the like. Based upon the information or signals received from these sensors, devices, and/or mechanisms, the content access detection system can determine if the user is in a position with respect to the active information handling device to be actively accessing content that is active or contained on the information handling device.

It should be understood that the example active access and/or consumption detection techniques are merely examples and are not intended to limit this disclosure to only those described techniques. Additionally, the content access detection system may use a combination of techniques to determine if content has been accessed and is being currently accessed by the user.

Using one or more of the described active access and/or consumption detection techniques, or other techniques, the content access detection system can determine if the user is currently or actively accessing the content at 302. If the user is not actively accessing the content, the content access detection system may take no action at 304. On the other hand, if the content access detection system determines the user is actively or currently accessing the content at 302, the content access detection system may track an amount of time the content is being accessed by the user at 303. In other words, the content access detection system may track an amount of time the content is actively accessed at 303.

Tracking the amount of time the content is actively accessed at 303 may be performed using one or more techniques. One technique is an event driven technique where a timer is started when the content is launched, loaded, opened, or otherwise initially accessed. Instead of, or in addition to, starting a timer, the system may simply log a timestamp corresponding to when the content is initially accessed, also referred to as a start timestamp. When the content is no longer actively being accessed, the timer would be stopped. If a timestamp is logged, when the content is no longer actively being accessed, a second timestamp corresponding to when the content is inactivated would be logged, also referred to as a finish timestamp. The length of time identified on the timer can then be logged and correlated to the content. For timestamps, the system can identify a difference between the finish timestamp and the start timestamp and log this time difference and correlate it to content. In the case that content is accessed multiple times, multiple timers and/or timestamp differences can be logged and marked as corresponding to the content. The aggregation of the multiple timers and/or timestamp differences would correspond to the amount of time the content was accessed.

Another technique for tracking the amount of time is a polling method. In this technique, an active counter is utilized. When the content is detected as being actively accessed, the counter can be incremented. Multiple counters may be used, with each counter corresponding to different content. Thus, if a user is switching back and forth between content, the counter is incremented each time the content becomes actively accessed by the user. The counter can then be logged with the content. The system may also use a combination of the event-driven and polling methods. This would allow the system to track a frequency of access of content and an amount of time the content is actively accessed.

When the content access detection system determines that content has been actively accessed for an amount of time, the content access detection system thereafter marks the content with the amount of time at 305. When marking the content, the system utilizes a marking technique that allows for sorting of the content based upon the amount of time, thereby providing a sorting technique (or other technique using similar methodology to sorting as described further herein) that allows for sorting content using a metric that more accurately identifies a relevancy of the content to the user than traditional sorting techniques. One marking technique includes updating the metadata of the content with the amount of time. In other words, the system binds the time to the content metadata. Another technique may include updating the content itself, and not the metadata, with the amount of time. Once the content is marked with the amount of time, the system can expose the amount of time to content searching like other metrics that are traditionally sortable, for example, date and/or time of last access, frequency of access, content title, and/or the like.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
detecting, using a content access detection system, content as content being accessed by a user;
tracking, using the content access detection system and while the content is being accessed by the user, an amount of time the content is being accessed by the user; and
marking, using the content access detection system, the content with the amount of time, wherein the marking comprises utilizing a technique that allows sorting of the content based upon the amount of time.

2. The method of claim 1, wherein the content is displayed on a display device and wherein the detecting comprises detecting a gaze of the user with respect to the content.

3. The method of claim 1, wherein the detecting comprises detecting the content is actively being audibly output.

4. The method of claim 1, wherein the detecting comprises detecting the content as active content.

5. The method of claim 1, wherein the content is displayed on a display device and wherein the detecting comprises identifying a size of the content with respect to other content displayed on the display device.

6. The method of claim 1, wherein the content is displayed on a display device and wherein the detecting comprises identifying a position of the content with respect to other content displayed on the display device.

7. The method of claim 1, wherein the detecting comprises detecting an identifier corresponding to the content as being active.

8. The method of claim 1, wherein the tracking comprises logging a start timestamp when the content is first accessed by the user and logging a finish timestamp when the content is no longer being accessed by the user; and
wherein the amount of time comprises a difference between the finish timestamp and the start timestamp.

9. The method of claim 1, wherein the tracking comprises utilizing a polling method that increments a counter when the content is accessed.

10. The method of claim 1, wherein the marking comprises updating metadata of the content.

11. An information handling device, the information handling device comprising:
a processor;
a memory device that stores instructions that, when executed by the processor, causes the information handling device to:
detect, using a content access detection system, content as content being accessed by a user;
track, using the content access detection system and while the content is being accessed by the user, an amount of time the content is being accessed by the user; and
mark, using the content access detection system, the content with the amount of time, wherein the marking comprises utilizing a technique that allows sorting of the content based upon the amount of time.

12. The information handling device of claim 11, wherein the content is displayed on a display device and wherein to detect comprises detecting a gaze of the user with respect to the content.

13. The information handling device of claim 11, wherein to detect comprises detecting the content is actively being audibly output.

14. The information handling device of claim 11, wherein to detect comprises detecting the content as active content.

15. The information handling device of claim 11, wherein the content is displayed on a display device and wherein to detect comprises identifying a size of the content with respect to other content displayed on the display device.

16. The information handling device of claim 11, wherein the content is displayed on a display device and wherein to detect comprises identifying a position of the content with respect to other content displayed on the display device.

17. The information handling device of claim 11, wherein to detect comprises detecting an identifier corresponding to the content as being active.

18. The information handling device of claim 11, wherein to track comprises logging a start timestamp when the content is first accessed by the user and logging a finish timestamp when the content is no longer being accessed by the user; and
wherein the amount of time comprises a difference between the finish timestamp and the start timestamp.

19. The information handling device of claim 11, wherein to track comprises utilizing a polling information handling device that increments a counter when the content is accessed.

20. A product, the product comprising:
a computer-readable storage device that stores executable code that, when executed by a processor, causes the product to:
detect, using a content access detection system, content as content being accessed by a user;
track, using the content access detection system and while the content is being accessed by the user, an amount of time the content is being accessed by the user; and
mark, using the content access detection system, the content with the amount of time, wherein the marking comprises utilizing a technique that allows sorting of the content based upon the amount of time.
